(19) United States
(12) Patent Application Publication
(10) Pub. No.: US 2018/0240210 A1
(43) Pub. Date: Aug. 23, 2018

(54) SYSTEM AND METHOD FOR TRANSPORTATION SCHEDULING AND PLANNING

(71) Applicant: OPTIBUS LTD, Netanya (IL)

(72) Inventor: Amos HAGGIAG, Netanya (IL)

(21) Appl. No.: 15/551,362

(22) PCT Filed: Feb. 16, 2016
(86) PCT No.: PCT/IL16/00002

§ 371 Date: Aug. 16, 2017

Related U.S. Application Data
(60) Provisional application No. 62/116,579, filed on Feb. 16, 2015.

(51) Int. Cl. G06Q 50/30; G06Q 10/10; G06Q 10/04; H04L 29/08

(52) U.S. Cl. CPC G06Q 50/30; H04L 67/14; G06Q 10/04; G06Q 10/1093

(57) ABSTRACT

A system and method whereby a user can create transportation scheduling, either on-line, off-line or real-time basis without consuming extended periods of time and readily capable of rapidly addressing new sets of parameters and/or readily facilitating interactive permutation and alteration scenario running including a client interface, an optimization engine electronically attached to client interface, wherein the optimization engine includes a in-memory state of at least one last optimization problem, a server responsive to input from the client interface, and a data set electronically attached to the server for scheduling transportation.

### FIELD OF THE INVENTION

The present invention relates to Scheduling systems. In particular, the present invention relates to transportation scheduling. More specifically, the present invention relates to novel improvements in transportation planning and allocation of resources.

### BACKGROUND OF THE INVENTION

There has long existed the need for an apparatus and system whereby a user can create transportation scheduling, either on-line, off-line or real-time basis without consuming extended periods of time and readily capable of rapidly addressing new sets of parameters and/or readily facilitating interactive permutation and alteration scenario running, either manually or automatically in accordance to predetermined prioritization.

This transportation scheduling and planning imperative coincides with an added desire to limit the allocation of resources and optimize available transportation resources. This has proven to be especially relevant to those in the public transportation field or bus and airline companies requiring a high degree of versatility and ability to plan, optimize, schedule, amend and change reactively to developing situations both expected and unexpected.

The traditional means of transportation scheduling and planning, has proven to have a number of significant drawbacks. The more prevalent of these drawbacks include the above-mentioned sources for a means of transportation.

Many “scheduler” systems and methods now exist attempting to ensure that users create offline Gantt schedules. The present invention introduces a new system and method for achieving a high degree of novel versatility and ability to create, edit, modify and run simulations as well as an optimization engine, such as displaying the cost difference after a change, or disallowing edits that are not valid.

Various prior art apparatuses and methods have been described and reviewed in earlier publications, which are incorporated herein by reference for all purposes as if fully set forth herein.

A series of computer programs are known in the art.

U.S. Pat. No. 8,781,726 discloses a method and system for adjusting a demand response transit schedule, reviewed during performance of the demand response transit schedule.

U.S. Pat. No. 8,521,577 discloses a method and system for paratransit run-cutting is provided. A target number of paratransit vehicles is determined for each of a set of time intervals. A target number of trips corresponding to the target number of paratransit vehicles is generated for each time interval, each of said mock trips being defined such that a vehicle performing one of said mock trips in one of said time intervals is able to perform any of said mock trips in an immediately subsequent one of said time intervals. The target number of mock trips for each of the time intervals is entered into a fixed-route transit run-cutting application. Paratransit runs are created using fixed-route transit runs generated by said fixed-route transit run-cutting application.

Furthermore, and by way of example only, a plurality of computer programs known as Trapeze™, Giro™ and IVU™ have attempted to facilitate creating a schedule and subsequently to perform an edit and then run an optimization engine. Nevertheless, the disclosed attempts in the programs known in the art still have many disadvantages. The programs known in the art do not teach accelerated updating/editing of solutions to day-to-day changes, accelerated updating/editing from the moment the change occur until the schedule can be changed, it may take a week or more, nor do the programs known in the art provide optimal scheduling for many manual edits, with no optimization engine to guard for efficiency.

Thus, such inventions as those described above generally suffer from at least one of several disadvantages, including, amongst others, attempted updating/editing with known programs often leads to Violations of operator rules, preferences, and regulations due to un-guarded manual editing. Therefore, the need exists to create a system and method whereby the foregoing disadvantages are adequately remedied to provide an efficient and novel alternative, wherein a system will offer full interactivity between schedulers and the optimization engine, thus allowing the following modifications:
a) Execute optimization iteration while changing preferences and constraints.
b) Relocate a scheduled task for a first transportation resources to a second transportation resource, or from a first time slot to a second time slot duty, and getting recommendations on each alternative duty/transportations resource.
c) Lock multiple tasks into one schedule block—the scheduler can select multiple (or all) blocks which were assigned to a transportation resource, and mark the transportation resources as inseparable scheduled tasks block wherein subsequent rescheduling performed with the automated optimization system will treat the task block as a single task and merge the task block into a single transportation resource. Nevertheless, the tasks block can also be displaced and rescheduled as a manually as a whole entity by the scheduler and the same recommendation rules described in the relocate task process will apply here.
d) Insert a new transportation resource row—the scheduler can insert a new transportation resource row, along with the transportation resource type, which can be used to reschedule tasks from existing transportation resources into a specific transportation resource selected.
e) Change the time of one or more trips (departure, arrival, or both)

### SUMMARY OF THE INVENTION

The present invention is a system and method for transportation scheduling and plan.

### BRIEF DESCRIPTION OF THE DRAWINGS

FIG. 1 is a diagram view of a first embodiment of the system and method for transportation scheduling and plan demonstrating Sequence diagram of the interactive requests/responses; and

FIG. 2 is a block diagram view of the system and method for transportation scheduling and plan according to the present invention.

### DETAILED DESCRIPTION OF THE INVENTION

The system and method for transportation scheduling and plan according to the present invention, as described herein, readily facilitates updating/editing devoid of violations of operator rules, preferences, and regulations.

Preferably, the system and method for transportation scheduling and plan according to the present invention, provides an efficient and novel alternative, wherein the present system offers full interactivity between schedulers and the optimization engine, thus efficiently facilitating at least one of the following modifications selected from the group consisting of executing optimization iteration while changing preferences and constraints, relocating a scheduled task for a first transportation resources to a second transportation resource, or from a first time slot to a second time slot duty, incorporating recommendations on each alternative duty/transportations resource, locking multiple tasks into a schedule block, wherein the at least one block is readily selectable and which at least one blocks is assigned to a transportation resource, and mark the transportation resources as inseparable scheduled tasks block wherein subsequent rescheduling performed with the automated optimization system will treat the task block as a single task and will merge the task block together to a single transportation resource. Nevertheless, the tasks block can also be displaced and rescheduled as a whole manually by the scheduler and the same recommendation rules described in the relocate task process will apply here, inserting a new transportation resource row—the scheduler readily facilitates inserting a new transportation resource row, along with the transportation resource type, for rescheduling tasks from existing transportation resources into a specific transportation resource selected and changing the time of one or more trips (departure, arrival, or both).

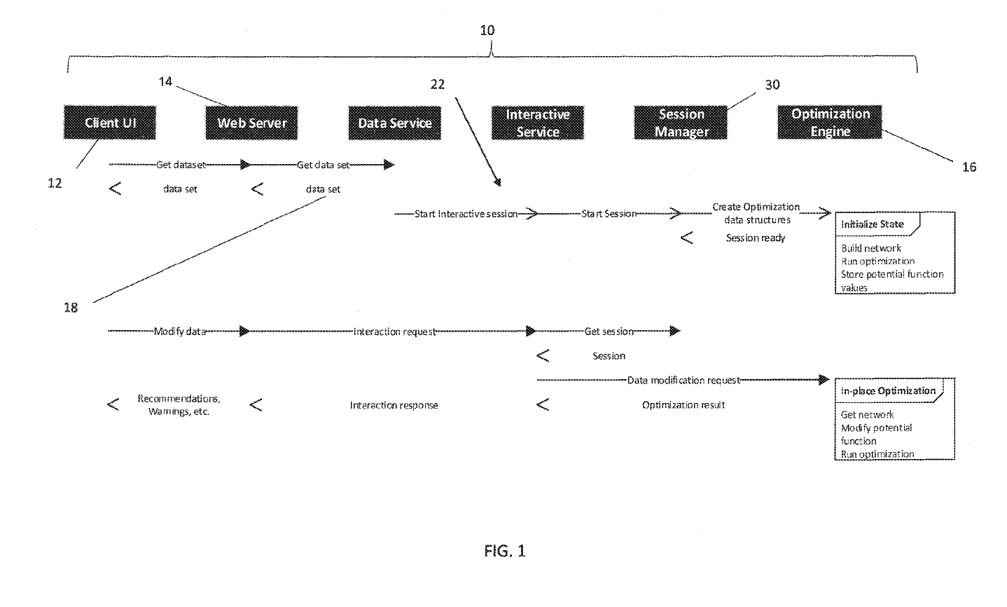

As shown in FIG. 1, a system and method for transportation scheduling and plan 10 according to the present invention includes at least three elements: a client interface 12, wherein client interface 12 is preferably displayed as a Gantt chart, a server 14 wherein server 14 preferably includes an optimization engine 16 and a data set 18, wherein data set 18 preferably includes a plurality of tasks (not shown in FIG. 1) for scheduling.

Preferably, Server 14 is a Web server wherein server 14 is responsive to requests received from client interface 12. Preferably and thereafter, server 14 transfers requests to optimization engine 16 or a second server, getting response and send it back to the client interface 12 for visualization. Optionally, optimization engine 16, is situated on a single hardware platform with web server 14.

Alternatively, system and method for transportation scheduling and plan 10 includes an optimization engine 16, and a web server 14, wherein optimization engine 16, and web server 14 are situated on at least two distinct and separate hardware platform.

Optionally, at least one component selected from the group consisting of: client interface 12, server 14, data service, interface service including scheduling process 22, session manager 30 and optimization engine 16 are remotely located and electronically connected to client interface 12.

Alternatively, at least on one component selected from the group consisting of: client interface 12, server 14, data service, interface service including scheduling process 22, session manager 30 and optimization engine 16 are wirelessly connected to at least one component selected from the group consisting of: client interface 12, server 14, data service, interface service including scheduling process 22, session manager 30 and optimization engine 16.

During an interactive scheduling process 22, client interface 12 preferably displays on an output module (not shown in FIG. 1) the current scheduling state of the tasks and server 14 will preferably hold a session which will preferably include a representation by optimization engine 16 of data set 18 as well as a current scheduling (not shown in FIG. 1).

Preferably, system and method for transportation scheduling and plan 10 can readily request a scheduling operation from server 14 via client interface 12 with the relevant constraints while asking server 14 to schedule specific tasks together and/or to specific vehicles.

Preferably, system and method for transportation scheduling and plan 10 can manually change the current scheduling by relocating tasks (such as dragging and dropping tasks in a Gantt chart) between vehicles and resources.

Occasioning on system and method for transportation scheduling and plan 10 relocating tasks between vehicles and resources, the current scheduling state is kept in sync with the server session, thereby facilitating minimal data transfer between the client interface 12) and server 14 on each change the client interface 12 performs and each optimization result server 14 generates.

As part of this process system and method for transportation scheduling and plan 10 preferably receives recommendations server 14 for each operation system and method for transportation scheduling and plan 10 attempts to complete, preferably by way of having both server 14 and the client interface 12 execute relevant optimization and validity logic associated to the operation.

Preferably, for the purpose of facilitating an interactive experience, server 14 returns a rapid response. Preferably and typically, the response provide by server 14 is significantly shorter than a minute. Optionally, the response provide by server 14 is shorter than a second. Preferably, the response provide by server 14 is substantially under 500 milliseconds.

To this end, server 14 preferably utilizes a memory module 26 by way of maintaining an in-memory state of the last optimization problem, represented as a network graph 28, which residual network of network graph 28 is substantially at a maximum flow. Upon optimization engine 30 receiving a request by way of client interface 12, a small number of adjustments are made to the network graph 28 that represent a minor manual change (e.g. changing a single trip start time).

Preferably and substantially subsequently, optimization engine 16 initiates an optimization process, using a plurality network flow algorithms.

Preferably, the optimization process starts from the last state as the initial state of the network, after applying the modifications.

The algorithms then run a full optimization, invariably completed very fast due to the tight potential on most edges. Occasioning on the algorithm not completing the process within 500 ms, the user is notified and can continue to work asynchronously.

Preferably, subsequently to system and method for transportation scheduling and plan 10 finishing the optimization, the user can see the optimization output, and system and method for transportation scheduling and plan 10 merges the changes made that were not part of the optimization requests.

Preferably, optimization engine 16 runs at least one additional optimization including the newly added changes.

As shown in FIG. 1, an exemplary sequence diagram of interactive calls between client and server is demonstrated.

Preferably, client interface 12 requests at least one data set 18 substantially subsequently to a session starting. Preferably, client interface 12 displays data set 18 on client interface 12.

Upon user modifications, the client passes the user modifications to server 14. Upon receiving a response which contains notifications selected from the group consisting of recommendations, warnings, and the like. Preferably, the notifications are displayed on client interface 12.

Preferably, interactive Server 14 receives a signal to start an interactive session when the user asks to get a data set 18, substantially contemporaneously with getting data set 18 from a database.

Preferably, the signal is passed to a Session Manager 30 for creating an optimization session.

Upon receiving an interactive request which includes the user modifications, server 14 requests the active session from Session Manager 30. The session contains the endpoint for directly communicating with the optimization engine that holds this session. Then, the interactive service directly communicates the modification to session optimization engine 16.

Preferably, Session Manager 30 receives a request for creating a session. Session manager 30 sends a request to the optimization engine 16 to create a new optimization instance with the dataset. Then, when receiving a request to get the session, session manager 30 returns the endpoint of the optimization instance.
Preferably, optimization engine 16 receives a request for creating a new optimization instance, wherein optimization engine 16 initiates a new optimization process which upon startup preferably including the steps:
   a. Parsing data set 18, validating data set 18, and creating in-memory objects from dataset 18
   b. Creating indices to access common fields (e.g. trip id, empty trip, etc.).
   c. Building a network flow graph 28 from the trips that represents the available connections between trips, with their associated costs according to cost functions and preferences.
   d. Optimizing the network by running minimum cost flow algorithms to obtain the min-cost flow of the network
   e. Storing the flow in the network, with the potential function (aka residual capacity) of the edges of the network, in-memory
Preferably, thereafter, on a data modification request which is received directly by the optimization instance, optimization engine 16 performs the steps:
   a. Finding the modified trips using the fast indices;
   b. Modifying the corresponding nodes in the network and their edges;
   c. Modifying the corresponding potential function values for the edges that are associated with the modified trips;
   d. Running network flow algorithms on the modified residual network; and
   e. Storing the modified network in memory module 26.

Thus, the result is returned to interactive server 14, and the modified data structures are saved for subsequent modifications on memory module 26.

The term “transportation” as used herein, shall include but will not be limited to: a means of conveyance or travel from one place to another including a vehicle or system of vehicles, such as a bus, a train, a ship, a boat, a taxi, a car, an automobile, a two and three wheeled vehicle, a sea vessel, an aircraft or an airborne carrier and the like for private and public conveyance of passengers or goods especially as a commercial enterprise.

The term “transportation resources” as used herein, shall include but will not be limited to: a means of transportation, a handler of a means of transportation, a bank energy sources for a means of transportation, a loading station for loading a means of transport, an off-loading station for off-loading a means of transport and the like.

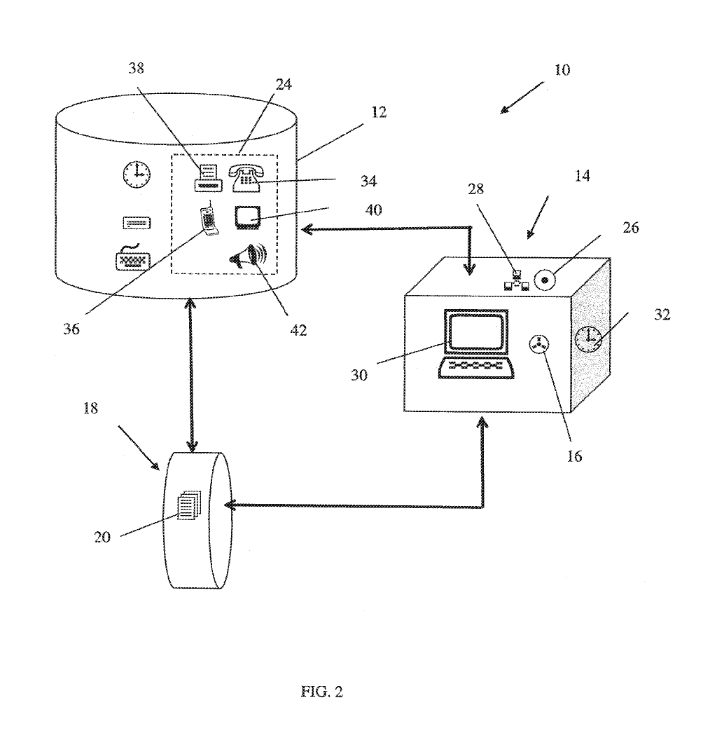

As shown in FIG. 2, a system and method for transportation scheduling and plan 10 according to the present invention includes at least three elements: a client interface 12, wherein client interface 12 is preferably displayed as a Gantt chart, a server 14 wherein server 14 preferably includes an optimization engine 16 and a data set 18, wherein data set 18 preferably includes a plurality of tasks 20 for scheduling.

During an interactive scheduling process 22, client interface 12 preferably displays on an output module 24 the current scheduling 32 state of the tasks 20 and server 14 will preferably hold a session which will preferably include a representation by optimization engine 16 of data set 18 as well as a current scheduling 32.

Optionally, output module 24 can be selected from the group consisting of: a wired telecommunication device 34, a wireless communication device 36, a physical output device 38, a display 40 and an audio device 42.

Optionally, output module 24 can include a dispatch and/or dispatcher for readily conveying schedule 32 to at least one intended recipient including but not limited to, a driver, a dedicated on-board system, a computerized relay, a cell phone and a display.

Preferably, system and method for transportation scheduling and plan 10 can readily request a scheduling 32 operation from server 14 via client interface 12 with the relevant constraints while asking server 14 to schedule specific tasks 20 together and/or to specific vehicles.

Preferably, system and method for transportation scheduling and plan 10 can manually change the current scheduling 32 by relocating tasks 20 (such as dragging and dropping tasks in a Gantt chart) between vehicles and resources.

Occasioning on system and method for transportation scheduling and plan 10 relocating tasks 20 between vehicles and resources, the current scheduling 32 state is kept in sync with the server session, thereby facilitating minimal data transfer between the client interface 12 and server 14 on each change the client interface 12 performs and each optimization result server 14 generates.

As part of this process system and method for transportation scheduling and plan 10 preferably receives recommendations server 14 for each operation system and method for transportation scheduling and plan 10 attempts to complete, preferably by way of having both server 14 and the client interface 12 execute relevant optimization and validity logic associated to the operation.

Preferably, for the purpose of facilitating an interactive experience, server 14 returns a rapid response. Preferably and typically, the response provide by server 14 is significantly shorter than a minute. Optionally, the response provide by server 14 is shorter than a second. Preferably, the response provide by server 14 is substantially under 500 milliseconds.

To this end, server 14 preferably utilizes a memory module 26 by way of maintaining an in-memory state of the last optimization problem, represented as a network graph 28, which residual network of network graph 28 is substantially at a maximum flow. Upon optimization engine 30 receiving a request by way of client interface 12, a small number of adjustments are made to the network graph 28 that represent a minor manual change (e.g. changing a single trip start time).

Preferably and substantially subsequently, optimization engine 16 initiates an optimization process, using a plurality network flow algorithms.

Preferably, the optimization process starts from the last state as the initial state of the network, after applying the modifications to the residual network.

The algorithms then run full optimization, which usually conclude rapidly due to the residual network preferably being substantially optimized tight potential on most edges. Occasioning on the algorithm not completing the process within 500 ms, the user is notified and can continue to work asynchronously.

Preferably, subsequently to system and method for transportation scheduling and plan 10 finishing the optimization, the user can see the optimization output, and system and method for transportation scheduling and plan 10 merges the changes made that were not part of the optimization requests.

Preferably, optimization engine 16 runs at least one additional optimization including the newly added changes.

Preferably, client interface 12 requests at least one data set 18 substantially subsequently to a session starting. Preferably, client interface 12 displays data set 18 on client interface 12.

Upon user modifications, the client passed the user modifications to server 14. Upon receiving a response which contains notifications selected from the group consisting of recommendations, warnings, and the like. Preferably, the notifications are displayed on client interface 12.

Preferably, interactive Server 14 receives a signal to start an interactive session when the user asks to get a data set 18, substantially contemporaneously with getting data set 18 from a database.

Preferably, the signal is passed to a Session Manager 30 for creating an optimization session.

Upon receiving an interactive request which includes the user modifications, server 14 requests the active session from Session Manager 30. The session contains the endpoint for directly communicating with the optimization engine that holds this session. Then, the interactive service directly communicates the modification to session optimization engine 16.

Preferably, Session Manager 30 receives a request for creating a session. Session manager 30 sends a request to the optimization engine 16 to create a new optimization instance with the dataset. Then, when receiving a request to get the session, session manager 30 returns the endpoint of the optimization instance.
Preferably, optimization engine 16 receives a request for creating a new optimization instance, wherein optimization engine 16 initiates a new optimization process which upon startup preferably including the steps:
   a. Parsing data set 18, validating data set 18, and creating in-memory objects from dataset 18
   b. Creating indices to access common fields (e.g. trip id, idle trip, etc.).
   c. Building a network flow graph 28 from the trips that represents the available connections between trips, with their associated costs according to cost functions and preferences.
   d. Optimizing the network by running minimum cost flow algorithms to obtain the min-cost flow of the network
   e. Storing the flow in the network, with the potential function (aka residual capacity) of the edges of the network, in-memory
Preferably, thereafter, on a data modification request which is received directly by the optimization instance, optimization engine 16 performs the steps:
   a. Finding the modified trips using the fast indices;
   b. Modifying the corresponding nodes in the network and their edges;
   c. Modifying the corresponding potential function values for the edges that are associated with the modified trips;
   d. Running network flow algorithms on the modified residual network; and
   e. Storing the modified network in memory module 26.

Thus, the result is returned to interactive server 14, and the modified data structures are saved for subsequent modifications on memory module 26.

It will be appreciated that the above descriptions are intended to only serve as examples, and that many other embodiments are possible within the spirit and scope of the present invention.

What is claimed is:

1. A system and method for transportation scheduling and plan comprising:
(a) a client interface;
(b) an optimization engine electronically attached to client interface, wherein said optimization engine includes a in-memory state of at least one last optimization problem;
(c) a server responsive to input from said client interface; and
(d) a data set electronically attached to said server for scheduling transportation.

2. The system and method for transportation scheduling and plan of claim 1, wherein said dataset further comprises a plurality of tasks.

3. The system and method for transportation scheduling and plan of claim 2, further comprising an output module.

4. The system and method for transportation scheduling and plan of claim 3, further comprising a session manager.

5. A system and method for transportation scheduling and plan comprising:
(a) a client interface including a output module;
(b) a server responsive to input from said client interface, wherein said server further includes a session manager;
(c) a data set electronically attached to said server for scheduling transportation and wherein said dataset further includes a plurality of tasks; and
(d) wherein said server electronically communicates with said client interface and output module to convey a scheduling a at least one recipient.

6. The system and method for transportation scheduling and plan of claim 1 further comprising full interactivity between at least one scheduler and said optimization engine, readily facilitating at least one modification selected from the group consisting of: executing optimization iteration while changing preferences and constraints, relocating a scheduled task for a first transportation resources to a second transportation resource, or from a first time slot to a second time slot duty, incorporating recommendations on each alternative duty/transportations resource, locking multiple tasks into a schedule block, wherein said at least one block is readily selectable and which said at least one block is assigned to a transportation resource, and marks the transportation resources as inseparable scheduled tasks block wherein subsequent rescheduling performed with the automated optimization system will treat the task block as a single task and merges said block together into a single transportation resource.

7. The system and method for transportation scheduling and plan of claim 1 wherein at least one component selected from the group consisting of: a server, a data service, an interface service including scheduling process, a session manager and optimization engine are remotely located and electronically connected to said client interface.

8. The system and method for transportation scheduling and plan of claim 1, wherein at least on one component selected from the group consisting of: said client interface, said server, a data service, an interface service including a scheduling process, a session manager and an optimization engine are wirelessly connected to at least one component selected from the group consisting of: a client interface, a server, a data service, interface service including a scheduling process, a session manager and optimization engine.

9. The system and method for transportation scheduling and plan of claim 1, wherein said in-memory state of a last optimization problem is represented as a network graph, wherein said network graph further comprises a residual network of network graph and is substantially at a maximum flow.

10. The system and method for transportation scheduling and plan of claim 9, wherein upon said optimization engine receiving a request by way of said client interface, a plurality of adjustments are made to said network graph representing a minor manual change.

11. The system and method for transportation scheduling and plan of claim 10, wherein said optimization engine initiates an optimization process, using a plurality network flow algorithms and wherein said optimization process starts from the last state as the initial state of the network, after applying at least one modification.
